(19) United States
(12) Patent Application Publication
(10) Pub. No.: US 2007/0109103 A1
(43) Pub. Date: May 17, 2007

(54) Commercial product activation and monitoring using radio frequency identification (RFID) technology

(75) Inventors: Thomas C. Jedrey, Pasadena, CA (US); Eric Archer, Pasadena, CA (US)

Correspondence Address: MARJAMA & BILINSKI LLP, 250 SOUTH CLINTON STREET, SUITE 300, SYRACUSE, NY, 13202, US

(73) Assignee: California Institute of Technology, Pasadena, CA (US)

(21) Appl. No.: 11/516,955

(22) Filed: Sep. 7, 2006

Related U.S. Application Data
(60) Provisional application No. 60/715,368, filed on Sep. 7, 2005.

(51) Int. Cl. H04Q 5/22

(52) U.S. Cl. 340/10.5; 340/5.2; 340/572.1; 340/5.61

(57) ABSTRACT

The invention provide retailers, distributors, purchasers, end-users and others in a commercial product's distribution chain with systems and methods for product activation at a specific point in the distribution chain (such as at the point of retail sale), for product validation and/or product maintenance (for example when the product is brought in for service or maintenance) and for product authentication (for example upon resale of the product). These capabilities, when added to the basic capability of an RFID-based system to provide an identity and a location for a tag attached to an object, endow commercial products with functionalities such as theft deterrence, product tracking and inventory management, inventory control and perimeter security, product maintenance and recordkeeping of service, and for high-end commercial products, a method of easily identifying a genuine item from a counterfeit.

### CROSS-REFERENCE TO RELATED APPLICATIONS

This application claims priority to and the benefit of co-pending U.S. provisional patent application Ser. No. 60/715,368, filed Sep. 7, 2005, which is incorporated herein by reference in its entirety.

### STATEMENT REGARDING FEDERALLY FUNDED RESEARCH OR DEVELOPMENT

The invention described herein was made in the performance of work under NASA contract NAS7-1407, and is subject to the provisions of Public Law 96-517 (35 U.S.C. §202) in which the Contractor has elected to retain title.

### FIELD OF THE INVENTION

The invention relates to methods for monitoring a commercial product during its lifecycle. In particular, the invention relates to methods of activating, interrogating and/or authenticating a commercial product using radio frequency identification (RFID) technology.

### BACKGROUND OF THE INVENTION

Commercial products, particularly electronic items, are subject to theft, piracy and unauthorized duplication. Many companies face the problem of having their commercial products stolen at some point during the manufacturing or distribution process, and later find those products being sold illegally, for example, on Internet auction sites. Companies are looking for a convenient way to prevent such losses.

Many large retailers have implemented the use of Radio Frequency Identification (RFID) tags affixed to the exterior of individual products, shipping boxes or to entire pallets of product for inventory management systems and for tracking product to attempt to limit theft, for example by identifying when a product passes a specific point, such as an exit of a facility. The problems of theft, piracy and unauthorized duplication, however, are still considerable. There is a need for systems that provide improved theft deterrence as compared to the present RFID-based tracking systems.

### SUMMARY OF THE INVENTION

The invention provide retailers, distributors, purchasers, end-users and others in a commercial product's distribution chain with systems and methods for product activation at a specific point in the distribution chain (such as at the point of retail sale), for product validation and/or product maintenance (for example when the product is brought in for service or maintenance) and for product authentication (for example upon resale of the product). These capabilities, when added to the basic capability of an RFID-based system to provide an identity and a location for a tag attached to an object, endow commercial products with functionalities such as theft deterrence, product tracking and inventory management, inventory control and perimeter security, product maintenance and recordkeeping of service, and for high-end commercial products, a method of easily identifying a genuine item from a counterfeit.

The invention provides a method for activating an object upon a transfer of the object, comprising the steps of: providing an object in a deactivated state, said object having an RFID-based communication system operatively connected thereto, said RFID-based system comprising an antenna operatively connected to an RFID chip having a memory; providing an RFID interrogator configured to communicate with said RFID-based communication system; accepting a payment for the purchase or lease of said deactivated object; and communicating between said RFID-based communication system operatively connected to said deactivated object and said RFID interrogator to provide at least one bit of digital data to said deactivated object whereby said deactivated object is made ready for normal use.

In one embodiment, the object is a commercial product.

In another embodiment, the deactivated object is made ready for normal use through operation of a product controller, wherein the product controller is operably connected to the RFID-based communication system.

In another embodiment, the deactivated object is made ready for normal use through operation of an activation protocol.

In another embodiment, the activation protocol utilizes a daily security key.

In some embodiments, the step of communicating between said RFID-based communication system and said RFID interrogator selectively activates some portion or all of the functional capability of the object.

In some embodiments, the step of communicating between said RFID-based communication system and said RFID interrogator causes an additional level of service or functional capability of the object to be activated.

The invention also provides a method for authenticating an object, comprising the steps of: providing an object having an RFID-based communication system operatively connected thereto, said RFID-based system comprising an antenna operatively connected to an RFID chip having a memory; providing an RFID interrogator configured to communicate with said RFID-based communication system; providing a database of information containing at least one datum unique to each object represented in said database, said database and said RFID interrogator in operative communication; communicating between said RFID-based communication system operatively connected to said object and said RFID interrogator to retrieve from said object at least one bit of digital data; comparing said at least one datum unique to said object represented in said database with said at least one bit of digital data retrieved from said RFID-based communication system to determine whether said object is authentic; and providing an indication as to whether said object is authentic or is not authentic.

In one embodiment, the object is a commercial product.

In another embodiment, the at least one datum unique to said object is an ID number.

In another embodiment, the ID number is a 32- to 64-bit unique and unalterable ID number.

In another embodiment, the 32- to 64-bit unique and unalterable ID number is based upon a proprietary algorithm. In another embodiment, the at least one datum unique to said object encodes inventory information. In another embodiment, the at least one datum unique to said object encodes product test history information.

In another embodiment, the at least one datum unique to said object encodes date, time or location-of-sale information. In another embodiment, the at least one datum unique to said object encodes a store code, a retailer identity code or a store identity code.

In another embodiment, the method additionally comprises the step of programming the at least one bit of digital data into the RFID chip prior to its retrieval.

The invention also provides a system for activating a deactivated object upon completion of a transaction relating to the object, comprising: an object in an initial deactivated state, said object having an RFID-based communication system operatively connected thereto, said RFID-based system comprising an antenna operatively connected to an RFID chip having a memory; an RFID interrogator configured to communicate with said RFID-based communication system; and a transaction station configured to accept a payment for completion of a transaction relating to said initially deactivated object; whereby, upon the acceptance of a payment for completion of the transaction, a communication between said RFID-based communication system operatively connected to said deactivated object and said RFID interrogator provides at least one bit of digital data to said deactivated object whereby said deactivated object is made ready for normal use.

In one embodiment, the transaction relating to said initially deactivated object is a purchase or a lease of said object.

In another embodiment, the object is a commercial product.

In another embodiment, the deactivated object is made ready for normal use through operation of a product controller, wherein the product controller is operably connected to the RFID-based communication system.

In another embodiment, the deactivated object is made ready for normal use through operation of an activation protocol.

In another embodiment, the activation protocol utilizes a daily security key.

In some embodiments, the communication between said RFID-based communication system and said RFID interrogator selectively activates some portion or all of the functional capability of the object.

In some embodiments, the communication between said RFID-based communication system and said RFID interrogator causes an additional level of service or functional capability of the object to be activated.

The invention also provides a system for authenticating an object, comprising an object to be authenticated, said object having an RFID-based communication system operatively connected thereto, said RFID-based system comprising an antenna operatively connected to an RFID chip having a memory; an RFID interrogator configured to communicate with said RFID-based communication system; a database of information containing at least one datum unique to each object represented in said database, said database and said RFID interrogator in operative communication; whereby a) communicating between said RFID-based communication system operatively connected to said object to be authenticated and said RFID interrogator to retrieve from said object to be authenticated at least one bit of digital data, and b) comparing said at least one datum unique to said object represented in said database with said at least one bit of digital data retrieved from said RFID-based communication system provides an indication as to whether said object is authentic or is not authentic.

In one embodiment, the object is a commercial product.

In another embodiment, the at least one datum unique to said object is an ID number.

In another embodiment, the ID number is a 32- to 64-bit unique and unalterable ID number.

In another embodiment, the 32- to 64-bit unique and unalterable ID number is based upon a proprietary algorithm.

In another embodiment, the at least one datum unique to said object encodes inventory information.

In another embodiment, the at least one datum unique to said object encodes product test history information.

In another embodiment, the at least one datum unique to said object encodes date, time or location-of-sale information.

In another embodiment, the at least one datum unique to said object encodes a store code, a retailer identity code or a store identity code.

In another embodiment, the at least one bit of digital data is programmed into the RFID chip prior to its retrieval.

The foregoing and other objects, aspects, features, and advantages of the invention will become more apparent from the following description and from the claims.

### BRIEF DESCRIPTION OF THE DRAWINGS

The objects and features of the invention can be better understood with reference to the drawings described below, and the claims. The drawings are not necessarily to scale, emphasis instead generally being placed upon illustrating the principles of the invention. In the drawings, like numerals are used to indicate like parts throughout the various views.

FIG. 1 shows an example of an RFID system and components.

FIG. 2 shows another example of a prior art RFID system and components.

FIG. 3 shows an example of vendor's inventory management system, depicted schematically as a graphical user interface (GUI). In this example, the vendor is an electronics manufacturer and information about the inventory locations of the vendor's “128 MB stick” product (i.e., a semiconductor thumb drive) are displayed in the GUI.

FIG. 4 is a schematic diagram of an example of an activation protocol, an embodiment of the inventive system and method used for a sale of an initially deactivated object.

FIG. 5 shows an example of a product lifecycle and uses of the methods of the invention within the lifecycle. The shaded box indicates the stage at which the “Activation Protocol” is initiated. An example of an activation protocol is shown in FIG. 4.

FIG. 6 shows an RFID system placed over a conveyer belt. Boxes containing a commercial product ready for shipment are scanned by the RFID system as they are moved under it by the conveyer belt.

FIG. 7 shows an RFID system embedded within a mobile conveyer belt.

FIG. 8 is a schematic diagram of the inventive system and method for confirming (or failing to confirm) authenticity of an object. This embodiment of the invention can also be used to maintain the object, for example, software/firmware updates or maintenance of a service record.

FIG. 9 shows Manchester Decoder correlator results for the Microchip MCRF-452 RFID chip.

FIG. 10 is a diagram showing an illustrative embodiment of an RFID device based on a MicroChip MCRF-450 series chip, according to the principles of the invention.

FIG. 11 is a diagram showing an illustrative embodiment of an RFID device based on an EM Microelectronics 4134 chip, according to the principles of the invention.

### DETAILED DESCRIPTION OF THE INVENTION

The invention provides systems and methods that are useful to allow a manufacturer or a vendor of a product to maintain the product in a condition that is “deactivated” (that is, in a condition in which the product will not perform its normal intended function) until there is an indication that the product is being purchased by an end-user. Upon receipt of such an indication, the product can be activated (that is, made to function as it is normally intended to function) by communications transmitted between an RFID chip and its associated components operatively attached to the product and an RFID interrogator and as needed a database under the control of the manufacturer or vendor. As will be explained, inventorying the product in a deactivated state and providing the activation procedure of the invention is useful to prevent the theft or other improper taking of the product from the manufacturer's supply chain, because an inactivated device is not useful. RFID-based communication systems

The invention provides a method for activating or authenticating an object. According to the invention, the object is operatively connected to an RFID-based communication system. RFID-based communication systems are well known in the art, as described, for example, in U.S. Pat. No. 6,247,033 to Kowalski Jun. 12, 2001, U.S. Pat. No. 6,249,227 to Brady et al. Jun. 19, 2001, U.S. Pat. No. 6,525,648 to Kubler et al. Feb. 25, 2003, U.S. Pat. No. 6,601,764 to Goodwin, III Aug. 5, 2003, U.S. Pat. No. 6,362,738 to Vega Mar. 26, 2002, and U.S. Patent Application Publication No. 2005/0234778 A1 published Oct. 20, 2005, each of which is incorporated herein by reference in its entirety.

The RFID-based system used in the methods and system of the invention comprises an antenna operatively connected to an RFID chip having a memory.

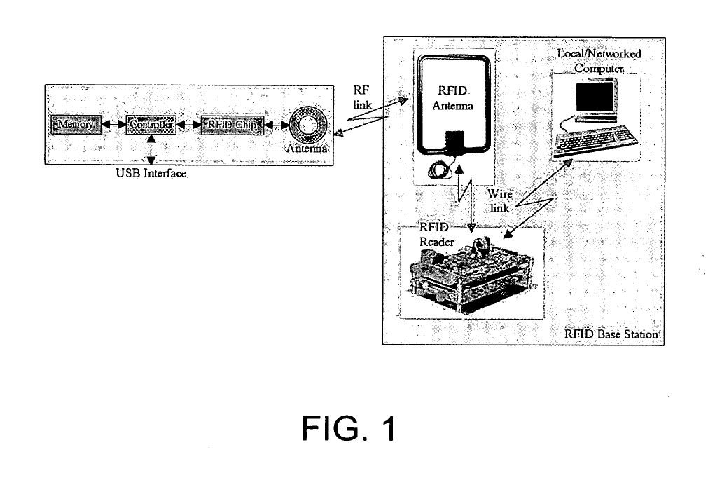

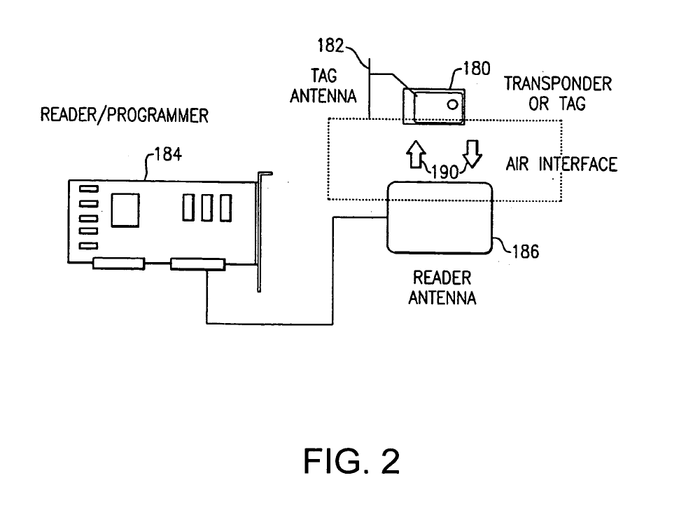

FIG. 1 and FIG. 2 show examples of typical RFID systems and components.

The AIM, Inc. White Paper entitled “Radio Frequency Identification—RFID A basic primer” (Document Version: 1.11 having a publication date of Sep. 28, 1999) provides an overview of some of the basic aspects of RFID systems. The following description is an edited excerpt from the AIM, Inc., document.

In general the exchange of data between tags and readers, such as the proximity device 110, is by wireless communication and two methods distinguish and categorize RFID systems. One method is based on close proximity electromagnetic or inductive coupling (e.g., the use of evanescent waves over distances short by comparison with a wavelength of the wave) and one is based on propagating electromagnetic waves. Coupling is via antenna structures forming an integral feature in both tags and readers. While the term antenna is generally considered more appropriate for propagating systems it is also loosely applied to inductive systems.

In RFID systems, transmitting data is subject to the vagaries and influences of the media or channels through which the data has to pass, including the air interface. Noise, interference and distortion are the sources of data corruption that arise in practical communication channels that must be guarded against in seeking to achieve error free data recovery. Moreover, asynchronous data communication processes require attention to the form in which the data is communicated. Channel encoding involves structuring the bit stream to accommodate these needs. The coding scheme applied appears in system specifications, and generally is transparent to the user of a RFID system. Various encoding schemes can be distinguished, each exhibiting different performance features.

The data is superimposed on a sinusoidally varying field or carrier wave to transfer data efficiently between the two communicating components. The superimposition process is referred to as modulation. Various schemes are available for this purpose, each having particular advantages. All of the schemes are based on changing the value of one of the primary features of an alternating sinusoidal source, such as its amplitude, frequency or phase in accordance with the data carrying bit stream. On this basis one can distinguish amplitude shift keying (ASK), frequency shift keying (FSK) and phase shift keying (PSK).

In addition to non-contact data transfer, wireless communication can also allow non-line-of-sight communication. However, with very high frequency systems more directionality is evident and can be tailored to needs through appropriate antenna design.

Carrier Frequencies

In wired communication systems the physical wiring constraints allow communication links and networks to be effectively isolated from each other. The approach that is generally adopted for radio frequency communication channels is to separate on the basis of frequency allocation. Generally covered by government regulation, different sections of the electromagnetic spectrum are assigned to different purposes. Three frequency ranges are generally distinguished for RFID systems, low, intermediate (medium) and high. Table 1 summarizes these three frequency ranges, along with the typical system characteristics and examples of major areas of application.

TABLE 1
Frequency Bands and Applications (from AIM White Paper)

| Frequency Band | Characteristics | Typical Applications |
|---|---|---|
| Low | Short to medium read range | Access control |
| 100-500 kHz | Inexpensive | Animal identification |
| | low reading speed | Inventory control |
| | | Car immobilizer |
| Intermediate | Short to medium read range | Access control |
| 10-15 MHz | potentially inexpensive | Smart cards |
| | medium reading speed | |
| High | Long read range | Railroad car monitoring |
| 850-950 MHz | High reading speed | Toll collection systems |
| 2.4-5.8 GHz | Line of sight required | |
| | Expensive | |

Data Transfer Rate and Bandwidth

Choice of field or carrier wave frequency is of primary importance in determining data transfer rates. In practical terms the rate of data transfer is influenced primarily by the frequency of the carrier wave or varying field used to carry the data between the tag and its reader. Generally speaking the higher the frequency the higher the data transfer or throughput rates that can be achieved. This is intimately linked to bandwidth or range available within the frequency spectrum for the communication process. According to the Nyquist Theorem, the channel bandwidth needs to be at least twice the bit rate required for the application in mind. Where narrow band allocations are involved the limitation on data rate can be an important consideration. It is clearly less of an issue where wide bandwidths are involved. Using the 2.4-2.5 GHz spread spectrum band, for example, 2 megabits per second data rates may be achieved, with added noise immunity provided by the spread spectrum modulation approach. Spread spectrum apart, increasing the bandwidth allows an increase noise level and a reduction in signal-to-noise ratio. Since it is generally necessary to ensure a signal is above the noise floor for a given application, bandwidth is an important consideration in this respect.

Range and Power Levels

The range that can be achieved in a RFID system is essentially determined by the power available at the reader/interrogator to communicate with the tag(s), the power available within the tag to respond, and the environmental conditions and structures, the former being more significant at higher frequencies including signal to noise ratio.

Although the level of available power is the primary determinant of range, the manner and efficiency in which that power is deployed also influences the range. The field delivered from an antenna extends into the space surrounding it and its strength diminishes with respect to distance. The antenna design will determine the shape of the field or propagation wave delivered, so that range will also be influenced by the angle subtended between the tag and antenna. Directional antennas may be used if the orientation between a tag and a reader will be known. The energy requirement for a directed beam to be read and understood is in general significantly lower than for an omnidirectional beam operating over the same distance. However, in many instances omnidirectional antennas will be needed because there is no way, a priori, to know how a tag and a reader will be aligned. In some instances, an antenna system that sweeps a beam of energy over an arc or angular range may be a good compromise.

As is commonly known in a space free of any obstructions or absorption mechanisms, the strength of a field reduces in inverse proportion to the square of the distance. For a wave propagating through a region in which reflections can arise from the ground and from obstacles, the reduction in strength can vary considerably, in some cases as an inverse fourth power of the distance. The phenomenon known as “multi-path attenuation” arises when there are different paths due to reflections and absorptions. At higher frequencies absorption due to the presence of moisture can further influence range. It is therefore important in many applications to determine how the environment, internal or external, can influence the range of communication.

In general the power available to the tag is significantly less than that available to the reader. This means that sensitive detection capabilities are useful within the reader to handle the return signals. In some systems the reader constitutes a receiver and is separate from the interrogation source or transmitter, particularly if the “up-link” (from transmitter-to-tag) carrier is different from the “down-link” (from tag-to-reader).

Basic features of an RFID transponder and its interaction with a reader/programmer are described in the AIM, Inc. White Paper entitled “Radio Frequency Identification—RFID A basic primer” (Document Version: 1.11, and having a publication date of Sep. 28, 1999), which has already been incorporated herein by reference. For example, a figure from that paper is reproduced here as FIG. 1 for the convenience of the reader. FIG. 1 depicts an RFID tag or transponder 180 with an antenna 182, a reader/programmer 184 in the form of a card designed to be installed in an expansion slot of a personal computer, and an antenna 186 attached to the reader/programmer 184. Interaction between the reader/programmer 184 and the tag 180 is shown as occurring across an air interface, and can be bi-directional, as indicated by the arrows 190.

The transponder can include memory, which memory can comprise any one or more of read-only (ROM), random access (RAM) and non-volatile programmable memory for data storage, depending upon the type and sophistication of the device. The ROM-based memory can be used to accommodate security data and the transponder operating system instructions which, in conjunction with the processor or processing logic deals with the internal management functions such as response delay timing, data flow control, and power supply switching. The RAM-based memory can be used to facilitate temporary data storage during transponder interrogation and response.

Non-volatile programmable memory may take various forms, electrically erasable programmable read only memory (EEPROM) being typical. Non-volatile memory can be used to store the transponder data. In some embodiments, non-volatile memory is used to ensure that the data is retained when the device is in its quiescent or power-saving “sleep” state. Some memory types, such as magnetic bubble memory, are inherently non-volatile.

Data buffers are further components of memory, used to temporarily hold incoming data following demodulation and outgoing data for modulation and interface with the transponder antenna. The interface circuitry provides the facility to direct and accommodate the interrogation field energy for powering purposes in passive transponders and triggering of the transponder response. Where programming is accommodated, facilities must be provided to accept the data modulated signal and perform the necessary demodulation and data transfer processes.

The transponder antenna is the structure by which the device senses the interrogating field and, where appropriate, the programming field and also serves as the means of transmitting the transponder response to interrogation.

A number of features, in addition to carrier frequency, characterize RFID transponders and form the basis of device specifications, including: the source of the transponder power, the transponder data carrying options, data read rates, programming options, and physical form.

Powering Tags

For tags to work they require power, albeit at a relatively low level (e.g., microwatts to milliwatts). Tags are either passive or active, the designation being determined entirely by the manner in which the device derives its power.

Active tags are powered by an internal battery and are typically read/write devices. They usually contain a cell that exhibits a high power-to-weight ratio and are usually capable of operating over a temperature range of −50° C. to +70° C. The use of a battery implies that a sealed active transponder has a finite lifetime. However, a suitable cell coupled to suitable low power circuitry can ensure functionality for as long as ten or more years, depending upon the operating temperatures, read/write cycles and usage. Alternative sources of energy such as solar cells or miniature fuel cells now in development are potentially useful for powering an active tag as the energy requirements of such a tag are relatively modest and easily within the capability of such alternative energy sources. In general terms, active transponders allow greater communication range than can be expected for passive devices, better noise immunity and higher data transmissions rates when used to power a higher frequency response mode.

Passive tags operate without an internal battery source, deriving the power to operate from the field generated by the reader. Passive tags are consequently much lighter than active tags, less expensive, and offer a virtually unlimited operational lifetime. The trade-off is that they have shorter read ranges than active tags and require a higher-powered reader. Passive tags are also constrained in their capacity to store data and may exhibit reduced ability to perform well in electromagnetically noisy environments. Sensitivity and orientation performance may also be constrained by the limitation on available power. Despite these limitations passive transponders offer advantages in terms of cost and longevity. They have an almost indefinite lifetime and are generally lower on price than active transponders.

Data Carrying Options

Data stored in data carriers invariable require some organization and additions, such as data identifiers and error detection bits, to satisfy recovery needs. This process is often referred to as source encoding. Standard numbering systems, such as UCC/EAN and associated data defining elements can be applied to data stored in tags. The amount of data depends on the application and requires an appropriate tag to meet the need. Categories used to classify data carried by tags includes: identifiers, in which a numeric or alphanumeric string is stored for identification purposes or as an access key to data stored elsewhere in a computer or information management system, and portable data files, in which information can be organized, for communication or as a method or instrument for initiating actions either independently or in combination with data stored elsewhere.

In terms of data capacity, tags are available from single bit to kilobits. The single bit devices can be used for surveillance purposes. Retail electronic article surveillance (EAS) is the typical application for such devices, being used to activate an alarm when detected in the interrogating field. They may also be used in counting applications.

Devices characterized by data storage capacities up to 128 bits can be used to hold a serial or identification number together, possibly, with parity check bits. Such devices may be manufacturer or user programmable. Tags with data storage capacities up to 512 bits, are frequently user programmable, and suitable for accommodating identification and other specific data such as serial numbers, package content, key process instructions or possibly results of earlier interrogation/response transactions.

Tags characterized by data storage capacities of around 64 kilobits may be regarded as carriers for portable data files, although they can be used for any purpose. With still larger capacity it is possible to organize data into fields or pages that may be selectively interrogated during the reading process.

Data storage ranges for RFID-based communication systems suitable for use in the invention can range from single data word (1-32 bits) to several Kbytes for financial transaction data.

Data Read Rate

As indicated above, the data transfer rate is essentially linked to carrier frequency. The higher the frequency, generally speaking, the higher the transfer rates. It should also be appreciated that reading or transferring the data requires a finite period of time, even if rated in milliseconds, and can be an important consideration in applications where a tag is passing swiftly through an interrogation or read zone.

Data Programming Options

Depending upon the type of memory a tag contains the data carried may be read-only, write once read many (WORM) or read/write. Read-only tags are invariably low capacity devices programmed at source, usually with an identification number. WORM devices are user programmable devices. Read/write devices are also user-programmable by allowing the user to change data stored in a tag. Portable programmers may be recognized that also allow in-field programming of the tag while attached to the item being identified or accompanied.

Physical Form of RFID Tags

RFID tags are typically available in a wide variety of physical forms, shapes sizes and protective housings. For example, animal tracking tags, inserted beneath the skin, can be as small as a pencil lead in diameter and ten millimeters in length. In addition, tags can be screw-shaped to identify trees or wooden items, or credit-card shaped for use in access applications. Anti-theft hard plastic tags attached to merchandise in stores are heavy-duty and have typical dimensions of 120 by 100 by 50 millimeters; other anti-theft tags measure approximately 1.5″.times.1.5″.times.0.003″ to 0.008″ thickness. Among other uses, these rectangular transponders can track commercial products, inter-modal containers, heavy machinery, trucks, railroad cars and the like for maintenance and business analysis and management operations.

RFID tags can be affixed or associated with an object by any method known in the art. According to the invention, the RFID-based communication system can be affixed to the object or to a component associated with the object, or embedded within or incorporated into the object or one of its components.

The RFID Reader or Interrogator

RFID readers and interrogators (also referred to herein to as “readers”) are well known in the art. RFID readers can differ quite considerably in complexity, depending upon the type of tags being supported and the functions to be fulfilled. In general, however, the overall function of a reader is to provide the means of communicating with the tags and facilitating data transfer. Functions performed by the reader include but are not limited to reading data, signal conditioning, parity error checking correction, or the like. Once a signal from a tag has been correctly received and decoded, algorithms may be applied to decide whether the signal is a repeat transmission. In the case that it is, the reader may then instruct the transponder to cease transmitting. This is commonly known as the “Command Response Protocol” and is used to circumvent the problem of reading multiple tags in a short space of time. The use of interrogators in this fashion can be referred to as “Hands Down Polling”. An alternative, more secure, but slower tag polling technique is called “Hands Up Polling” which involves the interrogator looking for tags with specific identities, and interrogating them in turn. This is contention management, and a variety of techniques have been developed to improve the process of batch reading. A further approach can use multiple readers, multiplexed into one interrogator.

RF Transponder Programmers

Transponder programmers are the mechanism by which data is delivered to write once, read many (WORM) and read/write tags. Programming is generally carried out off-line, at the beginning of a batch production run, for example.

For some systems, re-programming may be carried out on-line if, for example, the tag is being used as an interactive portable data file within a production environment. In some instances, data may need to be recorded during each process. Removing the transponder at the end of each process to read the previously processed data and to program new data increases processing time and detracts substantially from the intended flexibility of the application. By combining the functions of a reader and a programmer, data may be appended or altered in the transponder as required, without compromising the production line.

The range over which the programming can be achieved is generally less than the read range and in some systems near contact positioning is required.

Programmers are also generally designed to handle a single tag at a time.

RFID System Categories

Some categories employing RFID systems include: EAS (Electronic Article Surveillance) systems, portable data capture systems, networked systems, and positioning systems. EAS systems are typically a one bit system used to sense the presence/absence of an item. Retail stores frequently employ EAS systems where each item is tagged and large antenna readers are placed at exits to detect the unauthorized removal of the items.

Portable data capture systems are characterized by the use of portable data terminals with integrated RFID readers. These systems are tolerant to considerable variation in the sources of data read from tags. Typically a hand-held readers/portable data terminal is used to capture data that is then either transmitted directly to a host information management system via a radio frequency data communication (RFDC) link or held for delivery by line-linkage to the host on a batch processing basis.

In one embodiment of the invention, data is read by a portable data terminal, a hand-held proximity reader, or the like and then transmitted via line of sight communication to a reception unit. The line of sight communication can be in the form of a narrowly focused laser transmission. In a further embodiment, reception units are placed on the walls at set intervals so that within, for example, a warehouse or a retail establishment relatively little movement is required to achieve line-of-site communication. The line-of-site communication can happen over short distances (e.g., less than one meter) or up to long distances (e.g., tens of meters). In an additional embodiment, the reception units are able to receive simultaneous communications from a plurality of portable data terminals. In another embodiment, the reception units contain display systems for indicating whether the unit is available to receive transmissions.

Networked systems applications are generally characterized by fixed position readers deployed within a given site and connected directly to a networked information management system. The transponders are positioned on moving or moveable items, or people, depending upon application. However, other configurations are within the scope of this disclosure.

Positioning systems use transponders to facilitate automated location and navigation support for guided vehicles. Readers are positioned on vehicles and are linked to an on-board computer and communication connection to a host information management system. The transponders can be embedded in the floor of the operating environment and can be programmed with identification and location data. The reader antenna is typically located beneath the vehicle to allow closer proximity to the embedded transponders.

Areas of Application for RFID Systems

Potential applications for RFID system-based methods and systems of the invention include broad areas of industry, commerce, and services. The attributes of RFID are complementary to other data capture technologies and thus able to satisfy particular application requirements that cannot be adequately accommodated by alternative technologies.

Some of the areas of application for RFID include: transportation and logistics, manufacturing and processing, security, waste management, postal and package tracking, airline baggage reconciliation, road toll management, electronic article surveillance-clothing retail outlets being typical, protection of valuable equipment against theft, unauthorized removal or asset management, controlled access to vehicles, parking areas and fuel facilities (depot facilities being typical), controlled access of personnel to secure or hazardous locations, time and attendance—to replace conventional “slot card” time keeping systems, animal husbandry—for identification in support of individualized feeding programs, automatic identification of tools in numerically controlled machines—to facilitate condition monitoring of tools, for use in managing tool usage and minimizing waste due to excessive machine tool wear, identification of product variants and process control in flexible manufacture systems, sport time recording, electronic monitoring of offenders at home, vehicle anti-theft systems and car immobilizers.

A short overview of EPC technology is now presented. The description of features of the EPC technology is presented in far greater detail in publicly available documents. Version 1.0 of the EPCGlobal Network was released in September 2003, and offers a complete set of technical specifications for every component in the EPCGlobal Network, including the number system, tag, readers, and reference implementations on many software components. EPCGlobal Version 1.0 Specifications, available at www.epcglobalinc.com/standards_technology/specifications.htm-1, includes: EPC.TM. Tag Data Standards Version 1.1 Rev. 1.23, a 76 page document dated Feb. 16, 2004, which is available by activating a link on the web page identified in this sentence; a Technical Report entitled “13.56 MHz ISM Band Class I Radio Frequency Identification Tag Interface Specification: Candidate Recommendation, Version 1.0.0, a document comprising 31 pages plus front and back covers dated Feb. 1, 2003, which is available by activating a link on the web page identified in this sentence; a 46 page document dated Sep. 5, 2003 entitled “Auto-ID Reader Protocol 1.0” which is available by activating a link on the web page identified in this sentence; a 17 page document dated Aug. 12, 2003 entitled “Auto-ID Object Name Service (ONS) 1.0” which is available by activating a link on the web page identified in this sentence; a 58 page document dated Sep. 1, 2003 entitled “Auto-ID Savant Specification 1.0” which is available by activating a link on the web page identified in this sentence; and a 48 page document dated Sep. 15, 2003 entitled “PLM Core Specification 1.0” which is available by activating a link on the web page identified in this sentence; the entire disclosure of each of which is incorporated herein by reference in its entirety.

In brief, EPC is a tagging technology that provides the capability to identify a very large number of objects in a unique manner. EPC uses a digital identifier having 96 bits. Therefore, EPC in principle can identify 2⁹⁶ objects uniquely, or 7.92281625142643 E+28 objects (that is, at least 79,228,162,514,264,300,000,000,000,000, or something greater than 79 billion billion billion objects). The EPC tag is capable of being written to more than once. Therefore, an EPC tag can also include information, possibly in encoded form, about the object associated with the EPC tag, if fewer than all the 96 bits are used to identify the EPC tag and its associated object. Alternatively, an additional memory can be provided, of whatever convenient size, for storing information in association with the object. Memory sizes of at least 64 kilobits are possible. Using technology similar to conventional semiconductor memory, optical memory, or magnetic memory, larger memory sizes are attainable, up to megabit or gigabit capacity. Because a particular object can be identified precisely, and can be addressed individually, an EPC tag makes convenient the tracking, maintaining, upgrading, accounting for, and interacting with a particular object through an electronic tag as compared to the previous marking methods, such as the use of static bar codes, would cause such action to be possible only with great effort.

RFID technology can be used for many applications in a security system. Examples include controlling access to secure areas; securing, tracking and monitoring assets such as products and equipment; and routing, screening and sorting objects, such as packages. In one example, frequent travelers across the border between the U.S. and Canada can enroll in a program that employs biometrics (i.e., fingerprinting and digital photographs) and RFID technology in an ID card. The system when activated by the RFID proximity tag and the RFID reader displays information about the card holder, including a photo that can be used to identify a person as being permitted entry.

Programming

According to the invention, the RFID-based communication system comprises an RFID chip that has been programmed with at least one bit of digital data. Programming the RFID chip can be carried out using routine methods known in the art, and at desired points in the product's lifecycle, for example, during its manufacture or at some point along the distribution chain. Commercially available RFID chips generally bear a unique 32- to 64-bit identification number (UID), which is a non-changeable number written by RFID chip manufacturer. Random fill data can be written into non-used memory slots to slow hackers from activating the chip. Data storage ranges for RFID chips suitable for use in the invention can range from a single data word (1-32 bits) to several Kbytes, for example for use in maintaining financial transaction data. However, there is no limitation on the kind of data that can be stored in memory, including any type of data, any type of instruction or computer command, or any type of non-meaningful data used to pad a memory to a particular size. The data written in the memory can be written according to any convenient sequencing method, including sequential entry of data, entry of particular bits of data at specific locations, or entry of data in a sequence according to an algorithm. Meaningful data and non-meaningful data used to pad a memory to a particular size can be written in any order, and if desired, can be written in an intermixed sequence so long as the location of each bit of meaningful data is known or can be determined by the use of an algorithm.

In one embodiment, chip programming is carried out during a product's manufacture or fabrication, for example, at a manufacturing facility. Examples of digital data that can be programmed into the RFID chip during the product's manufacture include, but are not limited to: unique 32- to 64-bit identification number (UID), non-changeable number written by RFID chip manufacturer, random fill data written into non-used memory slots to slow hackers, inventory information (for example, when and where units were inventoried and by whom) product test history (for example, when and where units were tested or programmed), store code (e.g., 32-bit store code), retailer or chain store identity, specific store-or franchise number or identity.

Chip programming can also be carried out by a distributor or a selected point in a distribution channel. Examples of data parameters that can be programmed into the RFID chip include, but are not limited to: inventory information (for example, when and where units were inventoried and by whom), read and record serial numbers of product boxed for shipment, product test history (for example, when and where units were tested or programmed), store code (e.g., 32-bit store code), retailer or chain store identity, specific store or franchise number or identity (for example, programmed at the receiving dock during incoming inventory or when placed on the shelf).

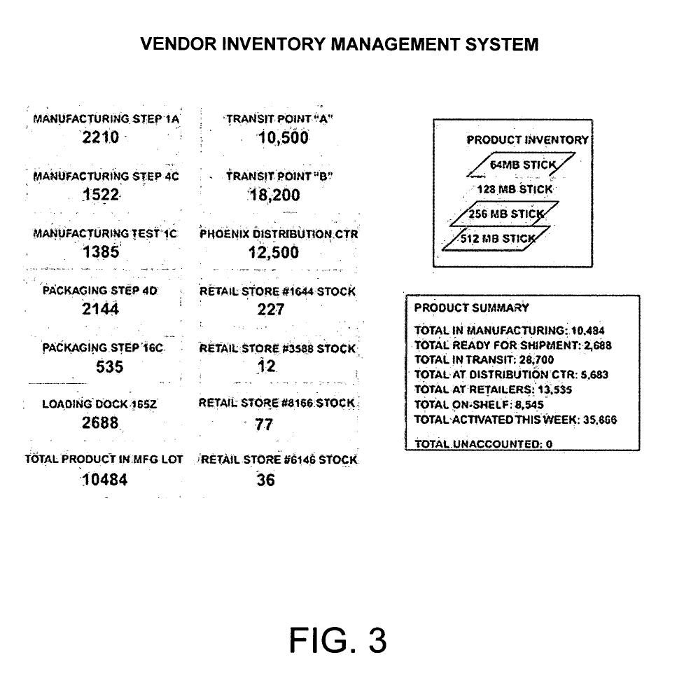

In one embodiment, a distributor's inventory management system is networked back to the manufacturer and provides the manufacturer with one or more data parameters about product location and status. For example, a serial number-based inventory system that is programmed into the RFID chip can enable the distributor to remove stolen product from active inventory. Information is reported in real- (or near-real) time, and can provide a strong method of tracking product in all areas of the distribution chain. FIG. 3 shows an example of vendor's inventory management system, depicted schematically as a graphical user interface (GUI).

The RFID chip can also be programmed at point-of-sale. In one embodiment, point-of-sale programming is performed by an activation protocol at a sales register. Examples of digital data that can be programmed at point-of-sale include, but are not limited to: date, time and location of sale, 32-bit time code (for example, “Jan. 17, 2006 14:32:17 Z” where “Z” denotes “Zulu” time or Greenwich mean time), store code (e.g., 32-bit store code), or serial number of a transaction. Such programmed information can provide traceability back to a specific customer and/or sales clerk.

Activation Methods and Systems

The invention provides a method for activating an object upon the sale (or lease or other form of transfer of ownership or title) of the object. When a payment is accepted (for example, at a point-of-sale) for the purchase or lease of a deactivated object, communication between the RFID-based communication system operatively connected to the deactivated object and the RFID interrogator provides at least one bit of digital data to the deactivated object whereby the deactivated object is made ready for normal use. According to this embodiment, the RFID chip essentially functions as an activation “switch.” Activation of the product can be accomplished in a brief period of time, for example, in less than 1 second.

Any method of payment known in the art may be used in accordance with the invention. For example, methods of payment suitable for use in the invention include, but are not limited to, payment by cash, bank draft or cheque, credit card, purchase order, wire transfer, line of credit or charge account with a vendor, a service agreement with a service provider such as a mobile telephone service agreement, barter, and in kind payment. The only requirement is that the vendor have assurance that the payment is being or will be made, so that the vendor has a good faith basis for considering the product to be sold, and not stolen. In some embodiments, the vendor may elect to give a product away, for example as a promotion, or by reimbursing a purchase price, in which circumstance the transaction is for no compensation in money or its equivalent to the vendor, but still falls under the contemplated invention. The transfer can be a sale, a lease, or any other legal transfer of the right to own or to use the object or product.

The invention also provides a system for activating a deactivated object upon completion of a transaction relating to the object. The system comprises an object in an initial deactivated state. The object has an RFID-based communication system operatively connected to it, and the RFID-based system comprises an antenna operatively connected to an RFID chip having a memory. Loop antennas, coil antennas and dipole antennas are examples of antennas known in the art that are suitable in the methods and systems of the invention. The system also comprises an RFID interrogator configured to communicate with the RFID-based communication system and a transaction station configured to accept a payment for completion of a transaction relating to the initially deactivated object. Upon the acceptance of a payment for completion of the transaction, a communication between the RFID-based communication system operatively connected to the deactivated object and the RFID interrogator provides at least one bit of digital data to the deactivated object, whereby the deactivated object is made ready for normal use.

Activation of an object can take place, for example, only at the point of sale. A stolen object cannot be activated and therefore will not be usable. The methods and systems of the invention are integrable into retail outlet infrastructure, and minimal training is needed to operate the activation equipment. The methods of the invention provide positive verification at point of sale that the product is activated. The methods employ low-cost, off-the-shelf technology using international standards, and are implementable in the United States, Asia, Europe and other locations. The methods of the invention involve only a minimal addition to existing manufacturing processes and facilities. The methods of the invention are resistant to the serious or sophisticated hacker, and enable a commercial supplier to ship several million products per year with minimal human intervention. The methods employ hardware that is small enough to consider implementation in form factors aid other than USB, and can be used to add additional security to products using cryptography options.

According to the invention, the process of legally purchasing a product operatively connected to the RFID-based communication system writes digital information to the RFID chip for immediate product activation or for later activation, interrogation or processing. The invention enables the product to be shipped from the factory in a “disabled” or “deactivated” state, and to be subsequently “activated” after a transaction, for example upon the acceptance of a payment completing the transaction, such as a sale or a lease to an end-user. Because the object is deactivated prior to the provision of information comprising at least one digital bit to the RFID-based system, the object will have little value on a “black” or “grey” market, e.g., if the object is stolen prior to being activated. Using encryption methods to be described in greater detail hereinbelow, it is possible to make the illicit provision of the correct information to activate the deactivated device quite complex, so that there is little incentive to acquire examples of the deactivated object that are known to be difficult to activate.

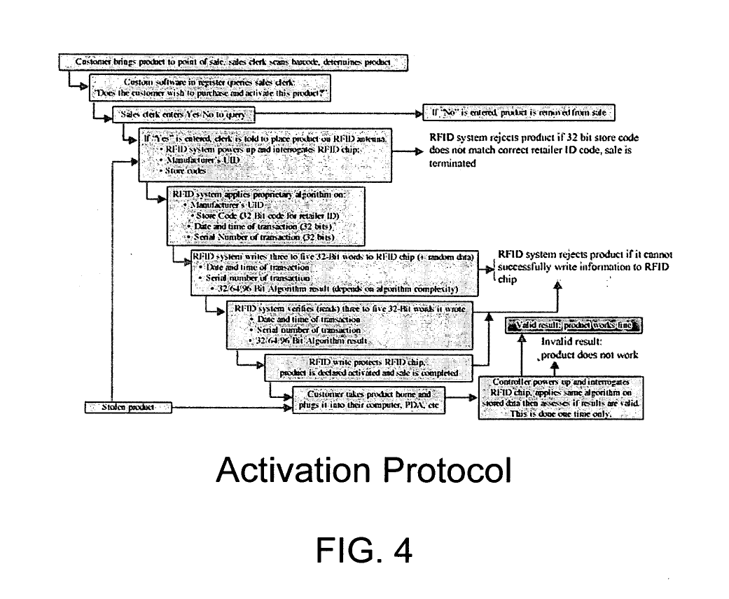

FIG. 4 is a schematic diagram of an example of an activation protocol, an embodiment of the inventive system and method used for a sale of an initially deactivated object. In this example, a customer brings a product (for example, a semiconductor thumb drive) to a point-of-sale, where the sales clerk scans the barcode and determines the identity of the product.

Custom software in the sales register queries the sales clerk: “Does the customer wish to purchase and activate this product?” The sales clerk enters Yes/No to the query.

If “No” is entered, the product is removed from sale.

If “Yes” is entered, the clerk is told to place the product on the RFID antenna. The RFID system powers up and interrogates the RFID chip about the manufacturer's UID and the store codes. If the 32-bit store code does not match the correct retailer ID code, the RFID system rejects the product and the sale is terminated.

If the 32-bit store code matches the correct retailer ID code, then the RFID system applies a proprietary algorithm on the manufacturer's UID, the store code (32-bit code for retailer ID), the date and time of transaction (32 bits), and the serial number of transaction (32 bits).

In the embodiment depicted, the RFID system writes three to five 32-bit words to the RFID chip (and may additionally write random data) encoding the date and time of the transaction, the serial number of the transaction, and a 32/64/96 -bit proprietary algorithm result (which depends on the algorithm complexity). As will be understood, in other embodiments, the proprietary algorithm can produce a result having any convenient number of bits.

If the RFID system cannot successfully write information to the RFID chip, it rejects the product.

The RFID system verifies (reads) the three to five 32-bit words it wrote, i.e., the date and time of the transaction, the serial number of the transaction, and the 32/64/96 -bit proprietary algorithm result.

If the RFID system cannot successfully verify the information to the RFID chip, it rejects the product.

If the RFID system successfully verifies the information to the RFID chip, the RFID system write-protects the RFID chip, the product is declared activated and the sale is completed.

If the RFID system cannot successfully write-protect the information to the RFID chip, it rejects the product.

If the RFID system successfully write-protects the information to the RFID chip, the customer or end-user takes possession of the product and attempts to use it, for example, at their home or place of business. In this example, the semiconductor thumb drive is plugged by the end-user into a computer, PDA, or other digital computing device. At this point, the controller associated with the product powers up and interrogates the RFID chip, applies the same proprietary algorithm on the stored data on the RFID chip, then assesses if the results are valid. In this example, this interrogation is performed only once. If a valid result is obtained, the product will be functional (“works fine”). If an invalid result is obtained, the product does not work.

According to this embodiment of the invention, a stolen product will not work when it fails to deliver the correct data when interrogated by the RFID system at the point of sale, or by the controller when use is attempted by the end-user.

As another embodiment, a product is activated using some portion or all of the capability that the hardware present in the product can provide. For example, at the point of sale (or activation), this method can be used to deliver various levels of service or capability, for example activation of any of 256 MB, 512 MB, or 1024 MB of a memory having at least 1024 MB of capacity provided in a memory stick or thumb drive. This allows a manufacturer to reduce the number of specific devices that must be manufactured, packaged, inventoried and tracked. The buyer pays for a level of service, which is then activated at the point of sale. The buyer can at a later time pay for additional capability and can have that additional capability activated upon such additional payment. In another embodiment, a software upgrade is provided that allows the product to perform additional functions or to comprise additional operative features that the hardware can support but that were not available under the pre-existing software. As an example, a cellular telephone can be upgraded from software version 1.08 to software version 1.10 to provide enhanced email capabilities. Authentication methods and systems

The invention provides a method for authenticating an object. According to the method, the RFID-based communication system is operatively connected to the object to be authenticated. A database of information is provided that contains at least one datum unique to each object represented in the database, and the database and the RFID interrogator are in operative communication with one another. The RFID interrogator and the RFID-based communication system communicate with one another to retrieve from the object to be authenticated at least one bit of digital data. At least one datum unique to the object represented in the database is compared with at least one bit of digital data retrieved from the RFID-based communication system to determine whether the object is authentic and an indication is provided as to whether the object is authentic or is not authentic.

The invention also provides a system for authenticating an object. The system comprises an object to be authenticated that has an RFID-based communication system operatively connected to it. The RFID-based system comprises an antenna operatively connected to an RFID chip having a memory. The system also comprises an RFID interrogator is configured to communicate with the RFID-based communication system. The system further comprises a database of information containing at least one datum unique to each object represented in the database. The database and the RFID interrogator are in operative communication. Communication between the RFID-based communication system operatively connected to the object to be authenticated and the RFID interrogator retrieves from the object to be authenticated at least one bit of digital data. At least one datum unique to the object represented in the database is compared with the at least one bit of digital data retrieved from the RFID-based communication system, which provides an indication as to whether the object is authentic or is not authentic.

Security

In certain embodiments, the invention provides “secure” and/or “hacker resistant” methods and systems. The RFID chip's ID number can be a unique and unalterable 32- to 64-bit ID programmed, for example, by the manufacturer (ISO-1 5693 requires this, which provides for 48 bits assigned to a UID). In principle, the unique ID number or UID can have a length of any convenient number of bits.

In one embodiment, the unique 32- to 64-bit number is based upon a proprietary algorithm. The proprietary algorithm can be sufficiently sophisticated such that it cannot be easily guessed (but is compatible, for example, with an 8-bit controller). The algorithm can be stored, for example, in a point-of-sale device (e.g., a point-of-sale computer or commercial cash register) and in the product controller. Point-of-sale devices and product controllers, for example, a commercially available 8-bit controller, can use any or all the above-mentioned information as input parameters.

In another embodiment, additional random information can be programmed into the chip to slow hackers. For example, all unused memory cells in the data memory can be filled with random data having no significance, rather than simply being left blank, or filled with a single repeating symbol. In addition, it is possible to use a randomizing algorithm to write the meaningful data in a format in which random data having no significance is interspersed with the meaningful data, so that not only must one know which memory cells contain that meaningful data, but also the order of presentation of the bits of that meaningful data.

By way of example, a memory having a capacity of 1024 bits, of which only 512 bits are actually used, poses a huge problem to solve, because first one has to know how many bits of real data are encoded, and secondly one has to correctly assemble only those bits, and in the correct order. In the example given, one can write 512 bits in a number of different permutations represented by 512! (that is, 512 factorial, or the product of every number from 1 to 512). Because digital data is represented only by 1's and 0's, not all of the permutations will necessarily be distinct. Nevertheless, this is a truly enormous number of possibilities. If one does not know in advance that the meaningful data occupies exactly 512 bits, but has to contend with the possibility that the data occupies 511 or 513 bits, (or maybe 723 bits), a brute force attack on the problem would not be expected to be accomplished in any reasonable amount of time. One should recall that meaningful data can be encoded in as little as one digital bit, for example as a flag, indicating a choice between two possible options, such as “deactivated” and “activated”.

In another embodiment, a point-of-sale computer is linked back to a previous entity in the product's distribution chain, for example the manufacturer or distributor, to provide a real-time (or near real-time) data parameter.

The complexity of the algorithm can be related to the speed of verification at a product's first turn-on. Such methods of generating complex algorithms are well known in the art.

In another embodiment, the algorithm incorporates, using routine methods, some level of random data such as date/time of sale, transaction serial number (quasi-deterministic) or pure random data (non- deterministic).

In another embodiment, the RFID chip is write-protected after programming (or writing) the chip with data parameter(s). Most commercially available RFID chips can be write-protected after programming.

In another embodiment, random data is written into empty cells to further confuse would-be hackers.

In another embodiment, a product controller is operably connected to the RFID-based communication system. In certain embodiments, the product controller reads all memory slots in the RFID chip, regardless of whether they are used by protocol. A serial link with the product controller can be embedded within the associated object to be activated.

In certain embodiments, two-way communication (for example, read/write) can be provided by an RF link. This arrangement can support, for example, dual (non-simultaneous) interfaces: RF and a hardwire serial link, such as the link to the product controller.

In another embodiment, specific retailer information is programmed in at a store (for example, store numbers such as “Vendor1 #207” or “Vendor2 #1061”).

In another embodiment, the UID is the data parameter that is used for verification and/or activation.

In another embodiment, the number of times that the product controller interrogates the RFID chip to verify valid codes is limited to a specified number of interrogations. This can be useful to avoid having a counterfeit product that is presented for verification “hang” the verification system if an unlimited number of attempts to read valid information is permitted to occur. In addition, if such a failure does occur, the system can be programmed to give an indication that the failure involved reaching the limit of the number of interrogations.

According to the invention, when the above actions are performed, defeating the security system is limited to, for example, replicating the data from a valid RFID chip (including unique ID) onto a replacement chip and physically replacing the invalid RFID chip. Such an effort is time-consuming and not cost effective for the “average” hacker. In some instances, the chip containing the memory data can also include other information or circuitry necessary for the operation of the object, for example programs such as a monitor program or a boot program, or circuitry necessary to provide control of a principal function of the device. In such instances, there may be no convenient source of the required chips for programming by a hacker, or the replacement of the chip may be so complex that the basic operation of the device is destroyed unless one has the tools needed to successfully replace the chip and restore all the necessary electrical connections. Hackers would therefore target other products with less robust protection than that afforded by the methods of the invention.

The methods of the invention can be employed to reduce retail product loss as well. A cryptography-based system can be incorporated using various encryption methods known in the art to provide a more secure and hacker-resistant system. For example, in one embodiment, an EM Microelectronics cryptography-based RFID chip is used in the methods of the invention. This RFID chip can be used to “lock-out” all attempted use of the product except by an owner or a registered user of a product.

In another embodiment, an activation protocol is used to activate the product in which a “Daily Security Key” is incorporated. Such a security key can be incorporated into the activation protocol using routine methods. For example, such activation can be accomplished in an embodiment in which a point-of-sale computer is linked with a manufacturer's inventory and product management system. The daily security key can be based on a sequence of data that must be entered into both the point-of-sale computer and into the manufacturer's inventory and product management system each day, for example at start-up, or at (or after) a specific time, such as 12:01 AM. This sequence of data can for example be data provided using a “one time pad” method known in the cryptographic arts. A “one time pad” is a system in which the sequence used to encrypt “plain text” into encrypted text is selected using a random key, which is used once and only once. The “one time pad” or “one time system” is well known in the cryptographic arts and is described, for example, in a book entitled The Codebreakers by David Kahn, published by MacMillan in 1967.

Hence a manufacturer that uses the methods of the invention can potentially have its product become the product-of-choice for retailers because it reduces theft and has minimal impact on their current sales system.

The methods of the invention are also advantageous because they are implementable with low cost, off-the-shelf technology. Furthermore, the RFID chips employed in the methods of the invention use international standards that can easily fit into a manufacturer's product line. According to the methods of the invention, the RFID chip is secure to all but the most tenacious hackers, and the RFID-based system can easily be integrated into a reseller's infrastructure.

Object Lifecycle and Usage

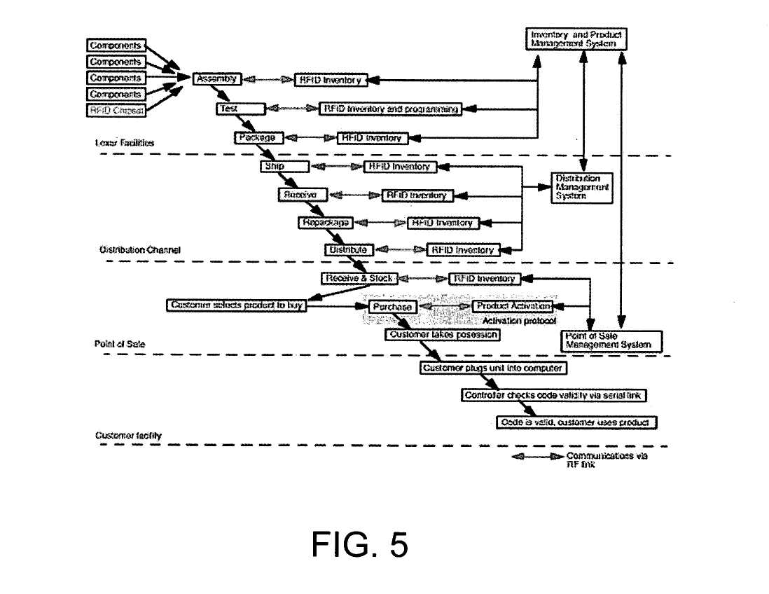

The methods and systems of the invention are employable in at least four main stages or areas of the object's or product's lifecycle or distribution chain. FIG. 5 shows an example of a product lifecycle and uses of the methods of the invention within the lifecycle. The invention uses infrastructure that allows an individual to communicate with an RFID-based communication connected to an object at any point in the lifecycle or any point in the distribution chain.

The methods of the invention can be used in a first main stage of the product lifecycle: during manufacture or assembly. In factories and facilities such as assembly areas, the methods and systems of the invention can be employed in inventory management and programming. Automated production methods are complimentary to RF-based communications, and mass quantities of product on a conveyer belt, for example, can be subjected to inventory management and programming using the methods of the invention. In a specific embodiment, the methods of the invention are used for automated identification of defective products before they are shipped.

In one embodiment, a conveyer belt reader is used that is hand-held, for example, a commercially available hand-held reader for retail store usage.

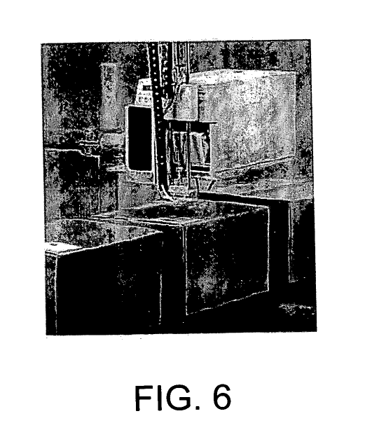

FIGS. 5 and 6 show a conveyer belt RFID programming systems. RFID tags can be programmed without human intervention. Each tag can be programmed in less than 0.05 second as it passes by an automated RFID programmer/interrogator. A scanner is placed around or next to conveyer belt. Product can be programmed and/or inventoried in bulk quantities.

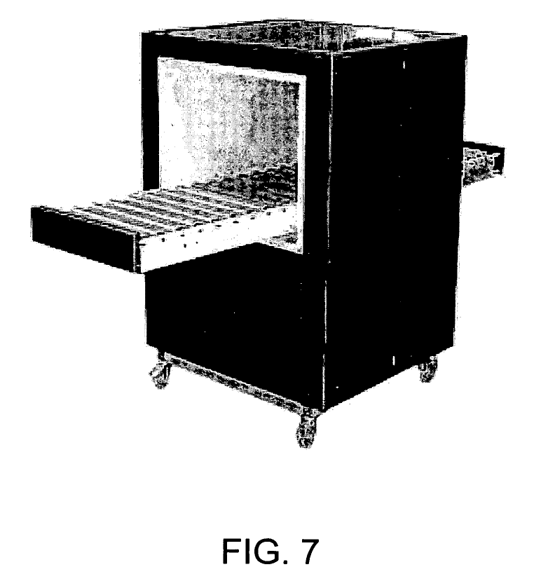

FIG. 5 shows an RFID inventory system placed over a conveyer belt. Either packaged or unpackaged product passes by the reader antenna. The RFID system can be coupled to an optical (barcode) scanner for more efficient inventory control. An RFID programming and interrogating system can also be embedded within a mobile conveyer belt (FIG. 7), which allows for flexible manufacturing and automation.

Second, the methods and systems of the invention can be employed in distribution channels. The methods and systems of the invention can be used for dock-to-dock cognizance of product being distributed to resellers. For example, shipping companies can inventory upon receiving a shipment of product and tell exactly where each individual product is in the supply chain. Examples of uses of the invention in inventory management include, but are not limited to: reading and recording serial numbers of product boxed for shipment, and writing information the RFID chips with respect to where, when or by whom units were inventoried. An inventory management system (for example, the distributor's inventory management system) can be networked back to the product's manufacturer. Such an arrangement is advantageous to the manufacturer in determining the location and status of their products. A serial number-based inventory system using the methods and systems of the invention enables stolen product to be removed from active inventory.

The methods of the invention are advantageous because information regarding one or more data parameters can be reported in real (or near-real) -time, which results in a strong method of tracking a product in all areas of the distribution chain

Third, the methods and systems of the invention can be employed at point-of-sale. Product can be inventoried at each handling step: receiving, stocking, shelving, and at checkout or upon sale. In one embodiment, each process step can continue to verify that the RF link to the product still functions.

According to the invention, individual store information can be programmed into the RFID chip, for example, retail store number, date and time when the product is shelved and the employee performing the stocking or shelving.

In one embodiment, a point-of-sale device interrogates the RFID chip associated with a product and stores pertinent data parameters on the chip in connection with the sale and activation of the product. In another embodiment, RFID readers at store entrances of the point-of-sale are used to determine whether a product is being removed (for example, stolen) from the premises.

Fourth, the methods of the invention can be used at a customer's or end-user's facility, for example at home or in an office. In one embodiment, the RFID chip linked to a product is inactive at the end user's facility. The end-user generally will not (or should not) have RF-based tools and software to communicate with tagged product. In this embodiment, the end-user presents the tagged product to an authorized facility for activation, validation or authentication.

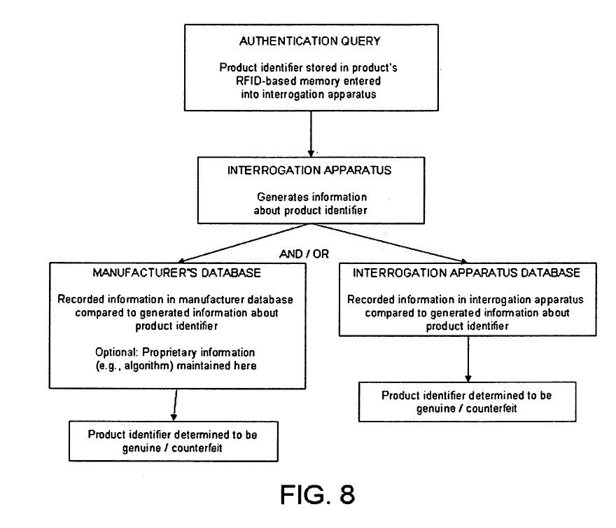

The customer or end-user may wish have an assured system and method for identifying an object as being genuine, rather than a counterfeit. This can be accomplished by interrogating the RFID chip linked to a product to determine whether the RFID chip contains a known sequence of specific data, which can be used to determine if the product is genuine or counterfeit, or to determine its provenance. FIG. 8 is a schematic diagram of the inventive system and method for confirming (or failure to confirm) authenticity of an object. This embodiment of the invention can also be used to maintain the object, for example, software/firmware updates or maintenance of a service record.

For example, a manufacturer of a product can encode data in a specific sequence based in part on an identifier provided on the product, such as a serial number. In one embodiment, as part of the identification procedure, the identifier is entered into the interrogation apparatus, and is used as at least part of the data needed to generate information such as the sequence, the location in memory and/or the content of at least one bit of digital data stored in the memory. If desired, the interrogation system can communicate the identifier to a data processing system under the control of the manufacturer, so that the algorithm need not be available outside of the control of the manufacturer. When the memory on the product is read, the recorded information is compared to the information generated in the interrogator (or in a data processing system under the control of the manufacturer) and a match of a predetermined number of bits of data can be used to indicate that the product is genuine. The methods and systems of the invention can be used, for example, to authenticate or determine the provenance of an expensive, luxury or “designer” product or the individual components of such a product, and to distinguish authentic goods from counterfeits or “knock-offs.” Examples of products (or their components) that are suitable for such authentication include, but are not limited to, consumer electronics and components, automobile components such as electronics (audio system components, GPS systems) and airbags, and expensive personal items such as watches, jewelry, luxury handbags, etc.

Machine-Readable Storage Media

Machine-readable storage media that can be used in the methods of the invention include electronic, magnetic and/or optical storage media, such as magnetic floppy disks and hard disks; a DVD drive, a CD drive that in some embodiments can employ DVD disks, any of CD-ROM disks (i.e., read-only optical storage disks), CD-R disks (i.e., write-once, read-many optical storage disks), and CD-RW disks (i.e., rewriteable optical storage disks); and electronic storage media, such as RAM, ROM, EPROM, Compact Flash cards, PCMCIA cards, or alternatively SD or SDIO memory; and the electronic components (e.g., floppy disk drive, DVD drive, CD/CD-R/CD-RW drive, or Compact Flash/PCMCIA/SD adapter) that accommodate and read from and/or write to the storage media. As is known to those of skill in the machine-readable storage media arts, new media and formats for data storage are continually being devised, and any convenient, commercially available storage medium and corresponding read/write device that may become available in the future is likely to be appropriate for use, especially if it provides any of a greater storage capacity, a higher access speed, a smaller size, and a lower cost per bit of stored information. Well known older machine-readable media are also available for use under certain conditions, such as punched paper tape or cards, magnetic recording on tape or wire, optical or magnetic reading of printed characters (e.g., OCR and magnetically encoded symbols) and machine-readable symbols such as one and two dimensional bar codes.

Many functions of electrical and electronic apparatus can be implemented in hardware (for example, hard-wired logic), in software (for example, logic encoded in a program operating on a general purpose processor), and in firmware (for example, logic encoded in a non-volatile memory that is invoked for operation on a processor as required). The present invention contemplates the substitution of one implementation of hardware, firmware and software for another implementation of the equivalent functionality using a different one of hardware, firmware and software. To the extent that an implementation can be represented mathematically by a transfer function, that is, a specified response is generated at an output terminal for a specific excitation applied to an input terminal of a “black box” exhibiting the transfer function, any implementation of the transfer function, including any combination of hardware, firmware and software implementations of portions or segments of the transfer function, is contemplated herein.

### EXAMPLE 1

RFID chips from EM Microelectronics and Microchip and RFID Readers from FEIG and Microchip were evaluated. PC boards were designed and tested around the two candidate chips and the strengths and weaknesses of each chip and reader were assessed. Loop antennas were then designed according to standard methods known in the art to work with each vendor's chip.

An RFID testbed was built using standard methods and used to test software and hardware elements together. The testbed included a desktop computer with a LABVIEW® graphical user interface (GUI) that simulated a manufacturer's product interface.

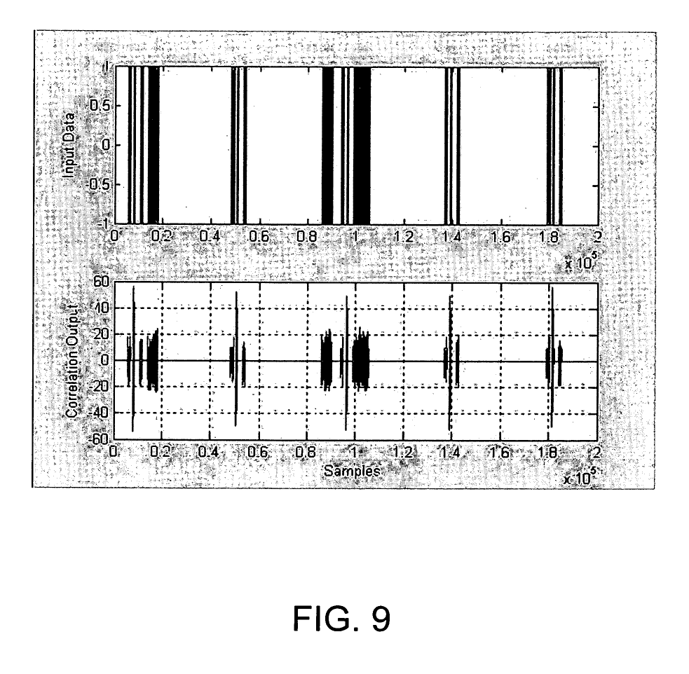

A Manchester Decoder was developed using standard methods to decode data from the RFID chips. FIG. 9 gives an example of Manchester Decoder correlator results for a Microchip MCRF-452 RFID chip.

Microchip Technology Inc MCRF-450 RFID Chip.

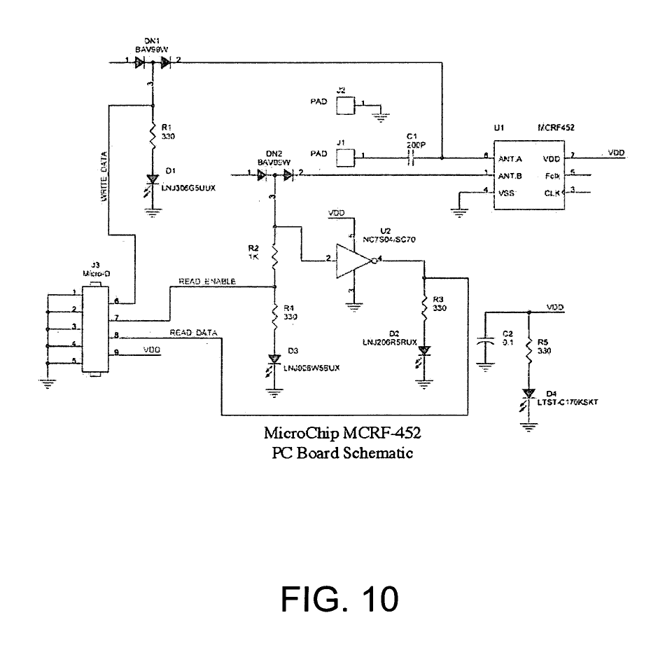

A Microchip Technology Inc. MCRF-450 was also selected for further evaluation. The MCRF-450 is single chip (which uses an antenna, a power supply and a clock) that supports two-way RF communications at 13.56 MHz. It is adaptable, using routine methods, to serial link communications. A reader can be built, using routine methods, to communicate with this chip. An exemplary circuit diagram showing a circuit in which the MCRF-450 is a component is shown in FIG. 10.

The MCRF-450 provides 29 blocks of 32-bit words for user read/write (928 bits) and can be permanently write-protected after programming. One 32-bit “unique” ID number is permanently programmed into chip. This ID number can be used to identify individual products during inventory and activation

Use of this chip in the methods of the invention can result in a “stovepipe” solution. This solution is based on a proprietary system of this manufacturer. The term “stovepipe” is used to denote a solution which is based on a unique or proprietary system, so that all additions to the system (e.g., any attempt to vertically integrate on the base system) ultimately has to be compatible with the requirements of the proprietary system, and parts, components, modules or systems available from other vendors may not be compatible, or may require extensive engineering efforts to accomplish an integrated system (for example, a software translator or a hardwired “patch board” to interface output signals provided by one system with the input requirements of another system). By comparison, many systems are design according to a standard used in an industry, for example a communication standard such as Ethernet or TCP/IP, so that any hardware or component that comports with the standard can be integrated into an operational system with only limited programming (which is generally provided by the vendor of the device) and generally no mechanical adjustments (e.g., plug to plug compatibility, or even “plug 'n play” compatibility).

EM Microelectronics EM-4134A RFID Chip

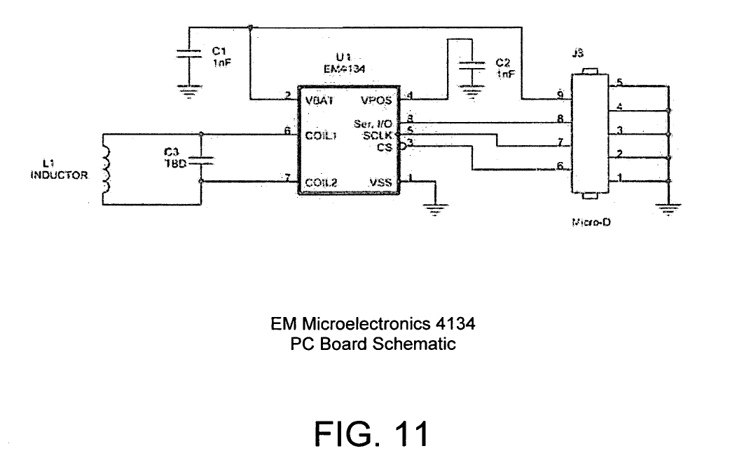

The EM Microelectronics EM-4134A RFID Chip was also evaluated. The EM-4134A is a single chip (which requires the addition of one passive component) that supports two-way RF communications at 13.56 MHz, and has both RF and serial link interfaces built-in. Its protocol partially compatible with international standards (ISO-15693). Commercially available readers can communicate with this chip. FIG. 11 is a diagram showing an illustrative embodiment of an RFID device based on an EM Microelectronics 4134 chip.

The EM-4134A has 14 blocks of 32-bit words available for user read/write (448 bits). It can be permanently write-protected after programming (RF only). Unused blocks can be used for other options or security features. One 32-bit “unique” ID number is programmed into chip that is changeable, but can be permanently set by the EM Microelectronics factory to make this ID un-changeable.

Although the theoretical description given herein is thought to be correct, the operation of the devices described and claimed herein does not depend upon the accuracy or validity of the theoretical description. That is, later theoretical developments that may explain the observed results on a basis different from the theory presented herein will not detract from the inventions described herein.

While the present invention has been particularly shown and described with reference to the structure and methods disclosed herein and as illustrated in the drawings, it is not confined to the details set forth and this invention is intended to cover any modifications and changes as may come within the scope and spirit of the following claims.

What is claimed is:

1. A method for activating an object upon a transfer of the object, comprising the steps of:
i. providing an object in a deactivated state, said object having an RFID-based communication system operatively connected thereto, said RFID-based system comprising an antenna operatively connected to an RFID chip having a memory;
ii. providing an RFID interrogator configured to communicate with said RFID-based communication system;
iii. accepting a payment for a purchase or lease of said deactivated object; and
iv. communicating between said RFID-based communication system operatively connected to said deactivated object and said RFID interrogator to provide at least one bit of digital data to said deactivated object whereby said deactivated object is made ready for normal use.

2. The method of claim 1 wherein the object is a commercial product.

3. The method of claim 1 wherein the deactivated object is made ready for normal use through operation of a product controller, wherein the product controller is operably connected to the RFID-based communication system.

4. The method of claim 1 wherein the deactivated object is made ready for normal use through operation of an activation protocol.

5. The method of claim 1 wherein the activation protocol utilizes a daily security key.

6. The method of claim 1 whereby the step of communicating between said RFID-based communication system and said RFID interrogator selectively activates some portion or all of the functional capability of the object.

7. The method of claim 6 wherein the step of communicating between said RFID-based communication system and said RFID interrogator causes an additional level of service or functional capability of the object to be activated.

8. A method for authenticating an object, comprising the steps of:
i. providing an object having an RFID-based communication system operatively connected thereto, said RFID-based system comprising an antenna operatively connected to an RFID chip having a memory;
ii. providing an RFID interrogator configured to communicate with said RFID-based communication system;
iii. providing a database of information containing at least one datum unique to each object represented in said database, said database and said RFID interrogator in operative communication;
iv. communicating between said RFID-based communication system operatively connected to said object and said RFID interrogator to retrieve from said object at least one bit of digital data;
v. comparing said at least one datum unique to said object represented in said database with said at least one bit of digital data retrieved from said RFID-based communication system to determine whether said object is authentic; and
vi. providing an indication as to whether said object is authentic or is not authentic.

9. The method of claim 8 wherein the object is a commercial product.

10. The method of claim 8 wherein the at least one datum unique to said object is an ID number.

11. The method of claim 10 wherein the ID number is a 32- to 64-bit unique and unalterable ID number.

12. The method of claim 11 wherein the 32- to 64-bit unique and unalterable ID number is based upon a proprietary algorithm.

13. The method of claim 8 wherein the at least one datum unique to said object encodes inventory information.

14. The method of claim 8 wherein the at least one datum unique to said object encodes product test history information.

15. The method of claim 8 wherein the at least one datum unique to said object encodes date, time or location-of-sale information.

16. The method of claim 8 wherein said at least one datum unique to said object encodes a store code, a retailer identity code or a store identity code.

17. The method of claim 8 additionally comprising the step of programming the at least one bit of digital data into the RFID chip prior to its retrieval.

18. A system for activating a deactivated object upon completion of a transaction relating to the object, comprising:
i. an object in an initial deactivated state, said object having an RFID-based communication system operatively connected thereto, said RFID-based system comprising an antenna operatively connected to an RFID chip having a memory;
ii. an RFID interrogator configured to communicate with said RFID-based communication system; and
iii. a transaction station configured to accept a payment for completion of a transaction relating to said initially deactivated object;
whereby, upon the acceptance of the payment for completion of the transaction, a communication between said RFID-based communication system operatively connected to said deactivated object and said RFID interrogator provides at least one bit of digital data to said deactivated object whereby said deactivated object is made ready for normal use.

19. The system of claim 18, wherein said transaction relating to said initially deactivated object is a purchase or a lease of said object.

20. The system of claim 18 wherein the object is a commercial product.

21. The system of claim 18 wherein the deactivated object is made ready for normal use through operation of a product controller, wherein the product controller is operably connected to the RFID-based communication system.

22. The system of claim 18 wherein the deactivated object is made ready for normal use through operation of an activation protocol.

23. The system of claim 18 wherein the activation protocol utilizes a daily security key.

24. The system of claim 18 wherein the communication between said RFID-based communication system and said RFID interrogator selectively activates some portion or all of the functional capability of the object.

25. The system of claim 24 wherein the communication between said RFID-based communication system and said RFID interrogator causes an additional level of service or functional capability of the object to be activated.

26. A system for authenticating an object, comprising
i. an object to be authenticated, said object having an RFID-based communication system operatively connected thereto, said RFID-based system comprising an antenna operatively connected to an RFID chip having a memory;
ii. an RFID interrogator configured to communicate with said RFID-based communication system;
iii. a database of information containing at least one datum unique to each object represented in said database, said database and said RFID interrogator in operative communication;
whereby
a) communicating between said RFID-based communication system operatively connected to said object to be authenticated and said RFID interrogator to retrieve from said object to be authenticated at least one bit of digital data, and
b) comparing said at least one datum unique to said object represented in said database with said at least one bit of digital data retrieved from said RFID-based communication system provides an indication as to whether said object is authentic or is not authentic.

27. The system of claim 26 wherein the object is a commercial product.

28. The system of claim 26 wherein the at least one datum unique to said object is an ID number.

29. The system of claim 26 wherein the ID number is a 32- to 64-bit unique and unalterable ID number.

30. The system of claim 29 wherein the 32- to 64-bit unique and unalterable ID number is based upon a proprietary algorithm.

31. The system of claim 26 wherein the at least one datum unique to said object encodes inventory information.

32. The system of claim 26 wherein the at least one datum unique to said object encodes product test history information.

33. The system of claim 26 wherein the at least one datum unique to said object encodes date, time or location-of-sale information.

34. The system of claim 26 wherein said at least one datum unique to said object encodes a store code, a retailer identity code or a store identity code.

35. The system of claim 26 wherein the at least one bit of digital data is programmed into the RFID chip prior to its retrieval.
